(19) United States
(12) Patent Application Publication
(10) Pub. No.: US 2016/0353015 A1
(43) Pub. Date: Dec. 1, 2016

(54) IMAGE SENSING DEVICE

(71) Applicant: Augustine Yen LIEN, Taipei (TW)

(72) Inventor: Augustine Yen LIEN, Taipei (TW)

(21) Appl. No.: 14/725,419

(22) Filed: May 29, 2015

(51) Int. Cl. H04N 5/232

(52) U.S. Cl. CPC H04N 5/23222

(57) ABSTRACT

An image sensing device includes a control unit, an image capturing unit, a sensing unit, a port and an alarm unit. The image capturing unit is connected to the control unit for capturing a user's image, and the control unit generates image data according to the image. The sensing unit is connected to the control unit for detecting the user to generate sensed data. The port is connected to the control unit provided for the control unit to transmit internal data or receive external data. The alarm unit is connected to the control unit for generating a warning signal according to at least one of the image data, the sensed data and the condition of the image sensing device. The multifunctional image sensing device may be applied in the areas of safety surveillance, pet monitoring, home care, or medical institutes.

### FIELD OF THE INVENTION

The present invention relates to the field of image capturing technology, in particular to a multifunctional image sensing device.

### BACKGROUND OF THE INVENTION

In general, a conventional image capturing device such as a webcam simply captures images and sends the images to a display device.

In view of the aforementioned deficiency, the present invention provides an image sensing device to improve the conventional image capturing device.

### SUMMARY OF THE INVENTION

It is a primary objective of the present invention to provide an image sensing device comprising an image capturing unit and a sensing unit for sensing a user's image and physiological status.

A secondary objective of the present invention is to provide the aforementioned image sensing device further comprising an alarm unit, such that if any one of the image, the image sensing device, and the physiological status is abnormal, then the alarm unit will warn the user or any other user.

To achieve the aforementioned and other objectives, the present invention provides an image sensing device comprising a control unit, an image capturing unit, a sensing unit, a port and an alarm unit. The image capturing unit is coupled to the control unit. The image capturing unit is provided for capturing an image of a user, and the control unit is provided for generating image data according to the image. The sensing unit is coupled to the control unit for detecting the user to generate sensed data. The port is coupled to the control unit for transmitting internal data or receiving external data. The alarm unit is coupled to the control unit.

Compared with the prior art, the image sensing device of the present invention not just captures image data through the image capturing unit only, but it also combines with a sensing unit to provide more information of the image data and provides a wider scope of applicability including the areas of safety surveillance, pet monitoring, home care, medical institutes, etc.

### BRIEF DESCRIPTION OF THE DRAWINGS

FIG. 1 is a schematic block diagram of an image sensing device in accordance with a first preferred embodiment of the present invention;

FIG. 2 is a schematic block diagram of an image sensing device in accordance with a second preferred embodiment of the present invention;

FIG. 3 is a schematic block diagram of an image sensing device in accordance with a third preferred embodiment of the present invention;

FIG. 4 is a schematic block diagram of an image sensing device in accordance with a fourth preferred embodiment of the present invention; and

FIG. 5 is a schematic block diagram of an image sensing device in accordance with a fifth preferred embodiment of the present invention.

### DESCRIPTION OF THE PREFERRED EMBODIMENTS

The aforementioned and other objects, characteristics and advantages of the present invention will become apparent with the detailed description of the preferred embodiments and the illustration of related drawings as follows.

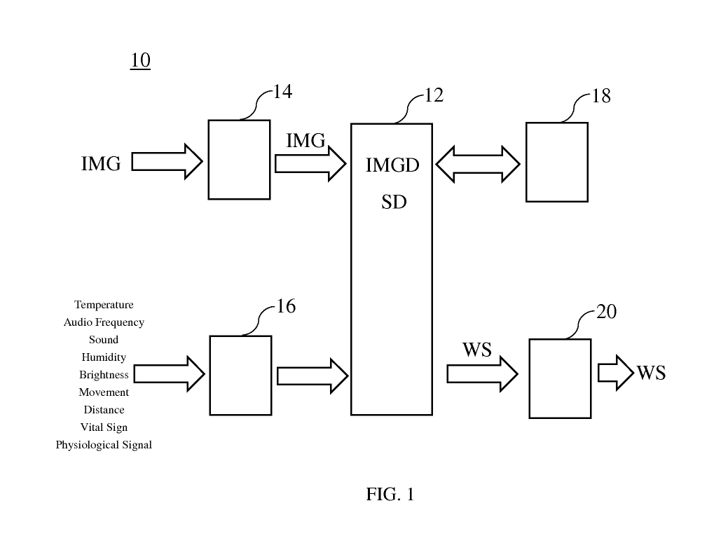

With reference to FIG. 1 for a schematic block diagram of an image sensing device in accordance with the first preferred embodiment of the present invention, the image sensing device 10 comprises a control unit 12, an image capturing unit 14, a sensing unit 16, a port 18 and an alarm unit 20.

The control unit 12 includes a plurality of computing elements (not shown in the figure) and a plurality of pins. The computing elements are capable of executing algorithms and analyses. For example, the control unit 12 is an AIT8455 digital signal processing integrated circuit (DSP IC).

The image capturing unit 14 is coupled to the control unit 12, wherein the image capturing unit 14 may be a charge-coupled device (CCD) component or a complementary metal oxide semiconductor (CMOS) component, and the resolution of the image capturing unit 14 may be a standard density (SD) resolution and/or a high definition (HD) resolution. The image capturing unit 14 is provided for capturing an image IMG of a user (not shown in the figure). The control unit 12 generates image data IMGD according to the image IMG.

The sensing unit 16 is coupled to the control unit 12 for sensing at least one selected from temperature, audio frequency, sound, humidity, brightness, movement, distance, physiological signal and vital sign. The sensing unit 16 is provided for detecting the user to generate sensed data SD.

The port 18 is coupled to the control unit 12, wherein the port 18 is one selected from an image transmission port, a sound transmission port and a data transmission port. For example, the port 18 is a universal serial bus (USB) port. The port 18 is provided for the control unit 12 to transmit internal data or receive external data. Wherein, the internal data are defined as data generated or processed by the control unit 12, and the external data are defined as data received from any unit or device other than the control unit 12.

The alarm unit 20 is coupled to the control unit 12, wherein the alarm unit 20 may provide a hardware alert or a software alert. For example, the alarm unit 20 alerts users through hardware such as a display screen, an indicating lamp, a speaker, or a vibrator or through software such as automatic notification. For example, the automatic notification refers to the function of sending a message to another sensing device or any other device (not shown in the figure) through the alarm unit 20 when the alarm is issued. The alarm unit 20 generates a warning signal WS according to at least one of the image data IMGD, the sensed data SD and the condition of the image sensing device 10 (such as abnormal software, abnormal hardware, abnormal firmware, or improper use).

For instance, an elderly person is at home alone, and the image sensing device 10 is installed to monitor the elderly person's related behaviors. The sensing unit 16 such as a temperature sensor of the image sensing device 10 is provided for sensing temperature, and the image capturing unit 14 captures the elderly person's image IMG, and the control unit 12 converts the image IMG into the image data IMGD. If the temperature sensor detects a change of the body temperature (such as an increase of body temperature) of the elderly person in the image IMG, then the control unit 12 will generate the warning signal WS through the alarm unit 20 according to the sensed data SD generated by the temperature sensor. For example, the warning signal WS is transmitted to a healthcare server via the Internet, so that a healthcare provider or administrator can provide necessary care to the elderly person through the healthcare server.

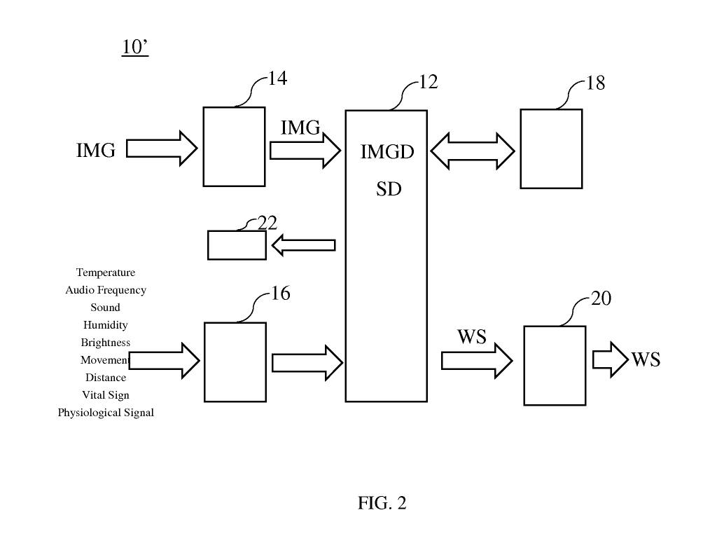

With reference to FIG. 2 for a schematic block diagram of an image sensing device in accordance with the second preferred embodiment of the present invention, the image sensing device 10′ further comprises a light source unit 22, in addition to the control unit 12, the image capturing unit 14, the sensing unit 16, the port 18 and the alarm unit 20 as described in the first preferred embodiment.

The light source unit 22 is capable of generating a visible light and a non-visible light. The light source unit 22 is coupled to the control unit 12. The light source unit 22 selectively adjusts the illumination according to the illumination of the image data IMGD to compensate the illumination of the image data IMGD.

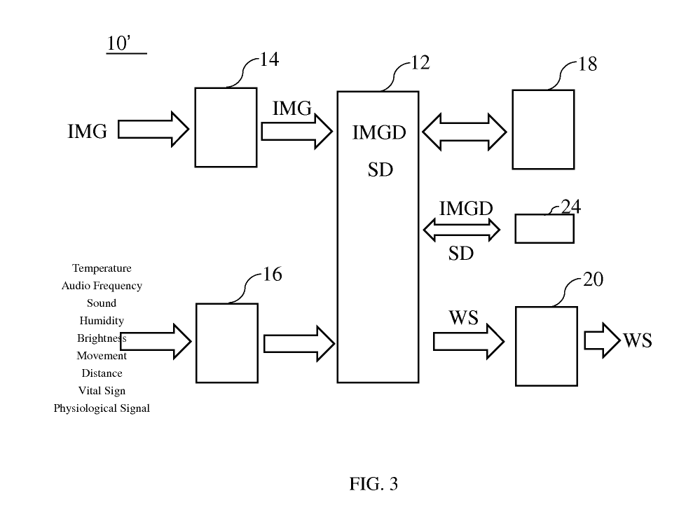

With reference to FIG. 3 for a schematic block diagram of an image sensing device in accordance with the third preferred embodiment of the present invention, the image sensing device 10″ further comprises a storage unit 24, in addition to the control unit 12, the image capturing unit 14, the sensing unit 16, the port 18 and the alarm unit 20 as described in the first preferred embodiment.

The storage unit 24 is coupled to the control unit 12. Wherein, the storage unit 24 is a built-in flash memory or an external flash memory such as a SD card or a USB flask drive. The storage unit 24 is provided for storing the image data IMGD and the sensed data SD.

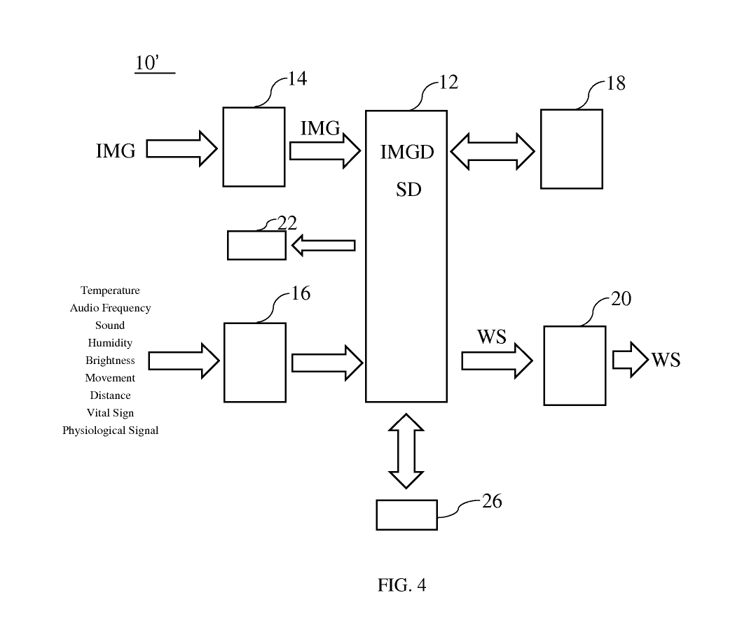

With reference to FIG. 4 for a schematic block diagram of an image sensing device in accordance with the fourth preferred embodiment of the present invention, the image sensing device 10′″ further comprises a communication unit 26, in addition to the control unit 12, the image capturing unit 14, the sensing unit 16, the port 18 and the alarm unit 20 as described in the first preferred embodiment.

The communication unit 26 is selectively coupled to at least one of the port 18 and the control unit 12. In this preferred embodiment, the communication unit 26 is coupled to the control unit 12 for transmitting at least one of the sensed data, the image data IMGD, and the warning signal WS. The communication unit 26 complies with at least one of a wireless communication specification and a cable communication specification. For example, the wireless communication specification includes a short-range communication protocol and a long-range communication protocol. The short-range communication protocol is a near field communication protocol, a Bluetooth communication protocol, a ZigBee communication protocol, a digital enhanced cordless telecommunications protocol or a wireless universal serial bus communication protocol, and the long-range communication protocol may be a wireless fidelity (Wi-Fi) communication protocol, a municipal wireless communication protocol, a general packet radio service communication protocol, a wireless broadband communication protocol, a worldwide interoperability for microwave access communication protocol, a time division duplexing communication protocol, a high speed packet access communication protocol, a high speed downlink packet access communication protocol, or a long term evolution communication protocol.

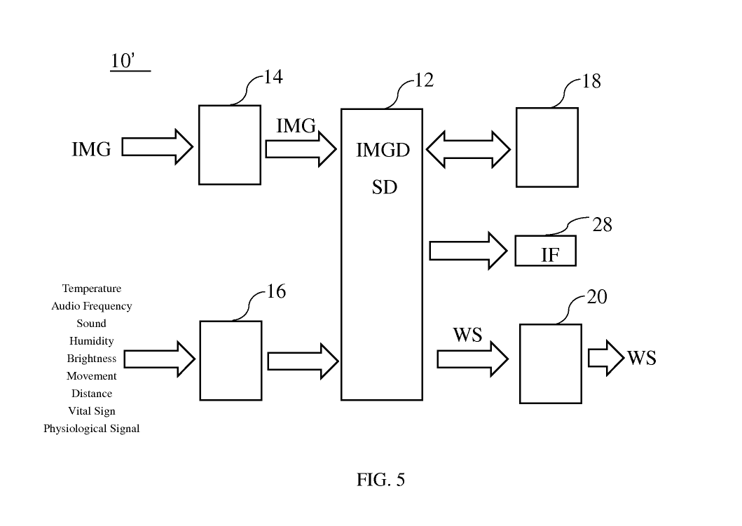

With reference to FIG. 5 for a schematic block diagram of an image sensing device in accordance with the fifth preferred embodiment of the present invention, the image sensing device 10″″ further comprises a display unit 28, in addition to the control unit 12, the image capturing unit 14, the sensing unit 16, the port 18 and the alarm unit 20 as described in the first preferred embodiment.

The display unit 28 is coupled to the control unit 12 for displaying an image frame IF. The image frame IF is corresponsive to at least one of the image data IMGD and the sensed data SD. In other words, the display unit 28 may display the image data IMGD and the sensed data SD.

The first to the fifth preferred embodiments may comprise a power supply unit (not shown in the figure) for generating and supplying electric power to at least of the control unit 12, the image capturing unit 14, the sensing unit 16, the port 18 and the alarm unit 20.

While the invention has been described by means of specific embodiments, numerous modifications and variations could be made thereto by those skilled in the art without departing from the scope and spirit of the invention set forth in the claims.

What is claimed is:

1. An image sensing device, comprising:
a control unit;
an image capturing unit, coupled to the control unit, for capturing an image of a user, and the control unit generating image data according to the image;
a sensing unit, coupled to the control unit, for detecting the user to generate sensed data;
a port, coupled to the control unit, provided for the control unit to transmit internal data or receive external data; and
an alarm unit, coupled to the control unit, the alarm unit, for generating a warning signal according to at least one of the image data, the sensed data and the status of the image sensing device.

2. The image sensing device as claimed in claim 1, further comprising a light source unit coupled to the control unit, for selectively adjusting the illumination according to the intensity of the illumination of the image data to compensate the illumination of the image data.

3. The image sensing device as claimed in claim 1, wherein the sensing unit is provided for sensing at least one selected from the group consisting of temperature, audio frequency, sound, humidity, brightness, movement, distance, physiological signal and vital sign.

4. The image sensing device as claimed in claim 1, further comprising a storage unit coupled to the control unit for storing at least one of the image data and the sensed data.

5. The image sensing device as claimed in claim 1, wherein the alarm unit provides a hardware alert and/or a software alert.

6. The image sensing device as claimed in claim 1, further comprising a communication unit coupled to the port and/or the control unit, and provided for transmitting at least one selected from the group consisting of the sensed data, the image data and the warning signal.

7. The image sensing device as claimed in claim 6, wherein the communication unit complies with at least one selected from the group consisting of a wireless communication specification and a cable communication specification.

8. The image sensing device as claimed in claim 1, further comprising a display unit coupled to the control unit for displaying an image frame corresponsive to at least one of the image data and the sensed data.

9. The image sensing device as claimed in claim 1, wherein the port is one selected from the group consisting of an image transmission port, a sound transmission port and a data transmission port.

10. The image sensing device as claimed in claim 1, further comprising a power supply unit for generating at least an electric power to be supplied to at least one selected from the group consisting of the control unit, the image capturing unit, the sensing unit, the port and the alarm unit.
